(19) United States
(12) Patent Application Publication
(10) Pub. No.: US 2007/0097403 A1
(43) Pub. Date: May 3, 2007

(54) Image processing system

(76) Inventors: Toshio Miyazawa, Kanagawa (JP); Fumihiro Hasegawa, Tokyo (JP); Hitoshi Itoh, Kanagawa (JP); Hiroaki Nagatsuka, Tokyo (JP)

Correspondence Address: DICKSTEIN SHAPIRO LLP, 1825 EYE STREET NW, Washington, DC, 20006-5403, US

(21) Appl. No.: 11/544,551

(22) Filed: Oct. 10, 2006

(30) Foreign Application Priority Data
Oct. 27, 2005 (JP) 2005-312835
Sep. 26, 2006 (JP) 2006-260845

(51) Int. Cl. G06F 3/12

(52) U.S. Cl. 358/1.13; 358/448

(57) ABSTRACT

An image processing system is disclosed that is able to provide an image suitable for a specified application. The image processing system includes a first image processing device for separating an input image into plural divisional images, which are processed by different image processing methods, in accordance with the output device of the input image; and a second image processing device for producing an output image suitable for a specified application from the divisional images. The first image processing device includes an image area division section for determining which of a first area and a second area, sub image areas of the input image belong to, and a selection section which uses the sub areas of the input image as the divisional images according to the determination results of the image area division section.

### BACKGROUND OF THE INVENTION

1. Field of the Invention

The present invention relates to an image processing system able to provide an image optimized for a specified application.

2. Description of the Related Art

In the related art, when outputting color images or grey scale images to a monochromatic printer, a facsimile machine, or other devices supporting only monochromatic output, the color image can be converted into a two-level image by using a fixed threshold value; then, the two-level image is output, or the whole image may be dithered or transformed into other format able to represent grades by a single color, and the output image is output.

FIG. 1A though FIG. 1C are views illustrating a color image or grey scale image, a two-level image, and a dithered image, respectively.

However, as shown in FIG. 1A through 1C, when the color or grey scale image is converted into a two-level image by using a fixed threshold value, although the text portion in the image can be output without quality degradation, the picture portion in the image becomes unrecognizable. In addition, when the color or grey scale image is dithered, although the picture portion in the image can be output with relatively small quality degradation, the visibility of the text portion is reduced.

For example, Japanese Laid Open Patent Application No. 2001-169099 (hereinafter, refer to as “reference 1”), and Japanese Laid Open Patent Application No. 2001-160900 (hereinafter, refer to as “reference 2”) disclose techniques enabling appropriate processing for the text portion and the picture portion, respectively.

FIG. 2 is a block diagram illustrating image processing in reference 1.

As shown in FIG. 2, on each small area of an input image, different filtering processing and multi-level dithering processing are performed in parallel, and one of the results of the image division processing is selected.

In the technique disclosed in reference 2, texts, pictures, and dots are determined, the text portions are converted into two-level data, the pictures and dots are dithered, and the results of these two processing are selected; hence, images of good quality are obtained even in the black-white mode.

Japanese Laid Open Patent Application No. 2001-111821 (hereinafter, refer to as “reference 3”) discloses a technique for correcting the unevenness of a two-level image by using an unevenness correction circuit so as to improve visibility of text on a background with optical density produced by dithering.

In the techniques disclosed in reference 1 and reference 2, the text portion and the picture portion are determined and are separated, and the picture portion is processed by dithering to produce an image. It is known that the above determination process is of a high workload.

Since the combined image is produced by using the determination results, when it is desired to view the image in the state of the original input image (color/grey scale image) instead of the image with the dithered picture portion, it is difficult to provide an image optimized for a specific application.

In order to provide the image optimized for a specific application without the high-workload determination process, for example, the input image can be stored in the original color image state, and according to the desired application, the image as a whole can be processed by dithering. However, in this method, as described above, the text portion is also dithered, and visibility of the text portion is degraded. In order to solve this problem, the technique in reference 3 is proposed for correcting the unevenness of a two-level image, but this technique requires to perform mask processing for each sub image area; thus if this processing is performed by software, it takes a very long time, and the problem cannot be solved.

### SUMMARY OF THE INVENTION

The present invention may solve one or more problems of the related art.

A preferred embodiment of the present invention may provide an image processing system able to provide an image suitable for a specified application.

According to a first aspect of the present invention, there is provided an image processing system, comprising:

a first image processing device configured to separate an input image into a plurality of divisional images in accordance with an output device, said divisional images being processed by different image processing methods; and

a second image processing device configured to produce an output image suitable for a specified application from the divisional images.

As an embodiment, the first image processing device comprises:

an image area division section configured to determine which of a first area and a second area each of a plurality of sub image areas of the input image belongs to; and

a selection section configured to use the sub image areas of the input image as the divisional images according to the determination result of the image area division section.

As an embodiment, the second image processing device comprises:

a filtering and dithering section configured to perform filtering and dithering on each of the divisional images according to one of a file format, a compression scheme, and an image bit number of the corresponding divisional image; and

a combining section configured to produce the output image by combining the images obtained by the filtering and dithering.

According to a second aspect of the present invention, there is provided an image processing system, comprising:

a first image processing unit configured to separate an input image into a plurality of divisional images in accordance with an output device, said divisional images being processed by different image processing methods; and

a second image processing unit configured to produce an output image suitable for a specified application from the divisional images.

As an embodiment, the first image processing unit comprises:

an image area division section configured to determine which of a first area and a second area each of a plurality of sub areas of the input image belongs to; and

a selection section configured to use the sub areas of the input image as the divisional images according to the determination result of the image area division section.

As an embodiment, the second image processing unit comprises:

a filtering and dithering section configured to perform filtering and dithering on each of the divisional images according to one of a file format, a compression scheme, and an image bit number of the corresponding divisional image; and

a combining section configured to produce the output image by combining the images obtained by the filtering and dithering.

According to a third aspect of the present invention, there is provided an image processing device, comprising:

a filtering and dithering section configured to input a plurality of divisional images, and perform filtering and dithering on each of the divisional images according to one of a file format, a compression scheme, and an image bit number of the corresponding divisional image; and

a combining section configured to produce an output image by combining the images obtained by the filtering and dithering.

As an embodiment, when the file format, the compression scheme, and the image bit number indicate the divisional images are color or grey scale images, the filtering and dithering section produces a two-level image able to represent a grade.

As an embodiment, the filtering and dithering section changes processing to be performed according to an output device of the output image.

According to a fourth aspect of the present invention, there is provided an image processing method, comprising the steps of:

inputting a plurality of divisional images, and performing filtering and dithering on each of the divisional images according to one of a file format, a compression scheme, and an image bit number of the corresponding divisional image; and

producing an output image by combining the images obtained by the filtering and dithering.

According to a fifth aspect of the present invention, there is provided a storage medium for storing an image processing program executable on a computer and able to drive the computer to carry out the steps of:

inputting a plurality of divisional images, and performing filtering and dithering on each of the divisional images according to one of a file format, a compression scheme, and an image bit number of the corresponding divisional image; and

producing an output image by combining the images obtained by the filtering and dithering.

According to a sixth aspect of the present invention, there is provided an image processing program executable on a computer and able to drive the computer to carry out the steps of:

inputting a plurality of divisional images, and performing filtering and dithering on each of the divisional images according to one of a file format, a compression scheme, and an image bit number of the corresponding divisional image; and

producing an output image by combining the images obtained by the filtering and dithering.

According to the present invention, it is possible to provide an image suitable for a specified application.

These and other objects, features, and advantages of the present invention will become more apparent from the following detailed description of preferred embodiments given with reference to the accompanying drawings.

### BRIEF DESCRIPTION OF THE DRAWINGS

FIGS. 1A though FIG. 1C are views illustrating a color image or grey scale image, a two-level image, and a dithered image, respectively;

FIG. 2 is a block diagram illustrating image processing in reference 1;

FIG. 3A through FIG. 3D are block diagrams illustrating examples of image processing systems according to an embodiment of the present invention;

FIG. 4 is a block diagram illustrating an example of the image processing device 1;

FIGS. 5A through FIG. 5D are views of images illustrating operations of the image processing device 1 according to the embodiment of the present invention;

FIG. 6 is a block diagram illustrating an example of the image processing device 2;

FIG. 7 is a block diagram illustrating an example of information included in an image file;

FIG. 8 is a data diagram illustrating data included in a PDF file;

FIG. 9 is a block diagram illustrating another configuration of the image processing device 2;

FIG. 10 is a sequence diagram illustrating operations of the image processing device 2 in FIG. 9, which generates and outputs images according to information of the output device; and

FIG. 11 is a sequence diagram illustrating another example of operations of the image processing device 2 in FIG. 9, which generates and outputs images according to conditions of the output device.

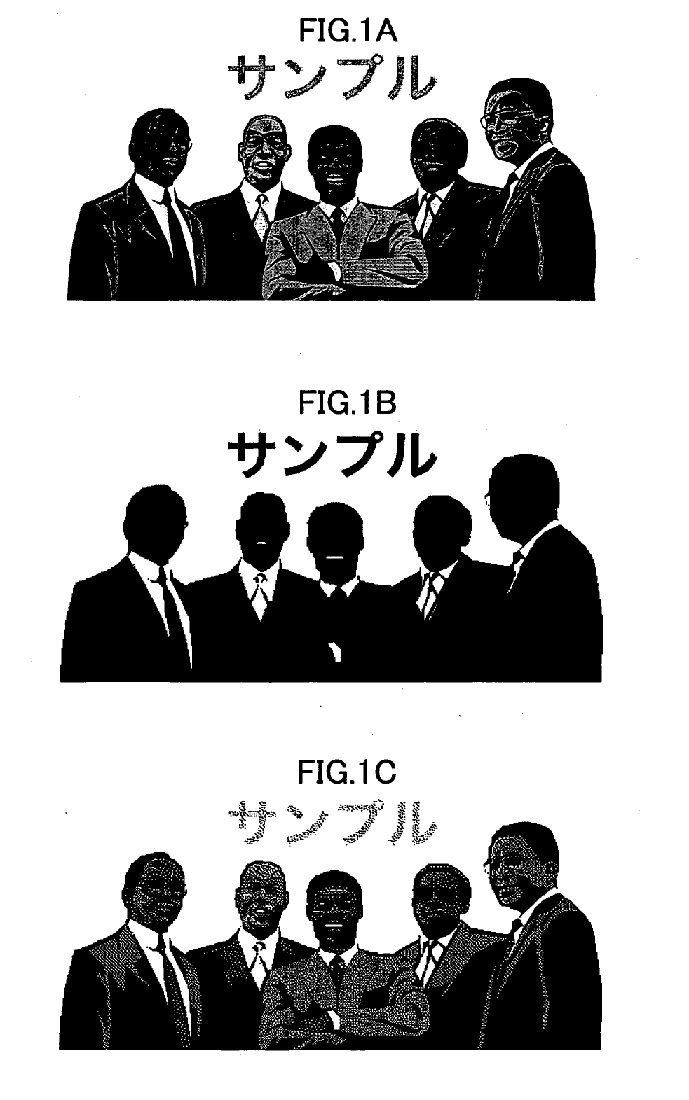

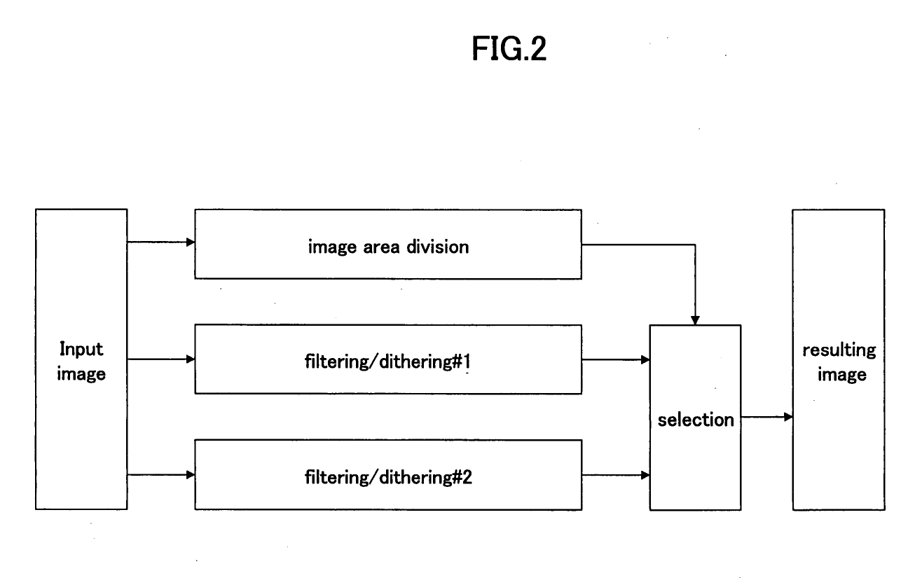

### DESCRIPTION OF THE PREFERRED EMBODIMENTS

Below, preferred embodiments of the present invention are explained with reference to the accompanying drawings.

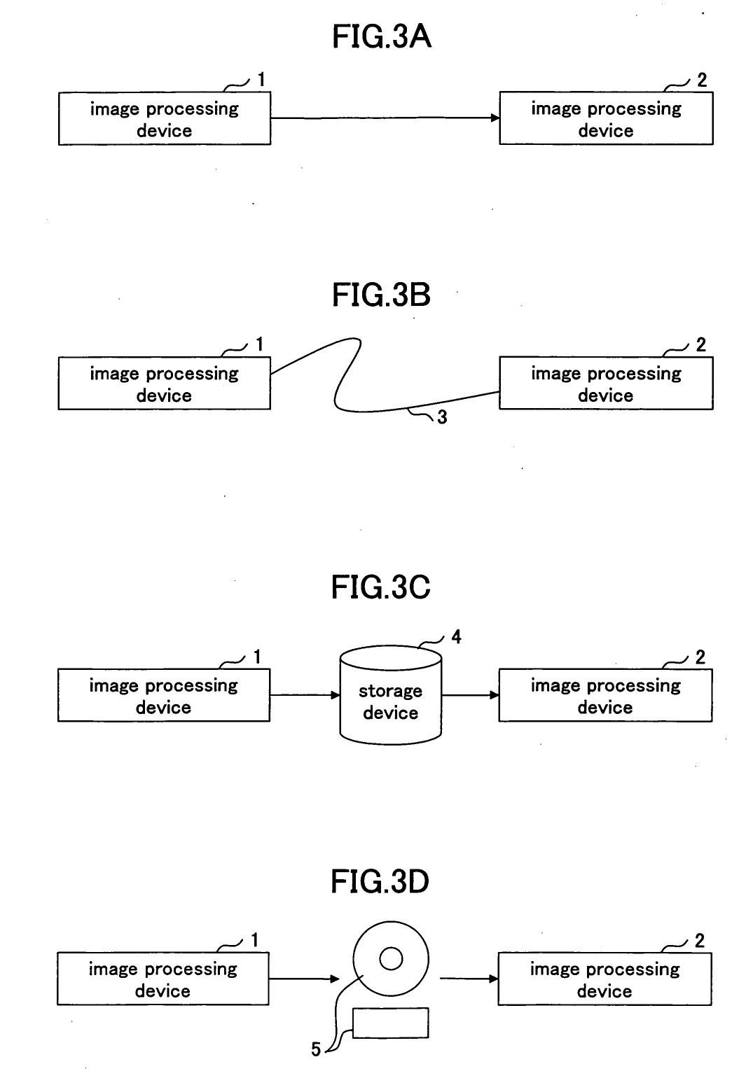

FIG. 3A through FIG. 3D are block diagrams illustrating examples of image processing systems according to an embodiment of the present invention.

Specifically, the image processing system in FIG. 3A includes an image processing device 1 which includes a MFP (Multi Function Printer) or a PC (personal computer), and generates plural divisional images from an input image; and an image processing device 2 which includes a PC, a PDA (Personal Digital Assistant), a mobile phone, a printer, or a facsimile machine, and produces an output image optimized for a specified application from the divisional images. The image processing device 1 is connected to the image processing device 2 directly. FIG. 3B shows an image processing system in which the image processing device 1 and the image processing device 2 are connected to each other through a network 3, such a LAN. FIG. 3C shows an image processing system in which a storage device 4, such as a hard disk drive (HDD) or a memory (RAM: Radom Access Memory), is provided between the image processing device 1 and the image processing device 2 for storing the plural divisional images produced by image processing device 1, and the divisional images are input from the storage device 4 to the image processing device 2 when necessary.

FIG. 3D shows an image processing system in which the plural divisional images produced by the image processing device 1 are temporarily stored in a medium 5, such as a CD or a memory device, and the divisional images are input from the medium 5 to the image processing device 2 when necessary.

It should be noted that each of the image processing systems shown in FIG. 3A through FIG. 3D can be a single device. That is, the elements of each of the image processing systems shown in FIG. 3A through FIG. 3D can be included in a single device.

In the related art, the text portion and the picture portion of an image are determined and are separated, and the picture portion is processed by dithering to produce an image. In order to carry out the determination at a high speed, generally, an ASIC (Application Specific Integrated Circuit) or other hardware is used. Since devices having such exclusively-used hardware are special, it is desired that the processing of determining and separating the text portion and the picture portion, and dithering the picture portion be performed by software.

However, processing by such software needs a long processing time, and it is difficult to perform real-time processing. Thus, for devices without ASIC, for example, the common personal computers, the PDAs, the mobile phones, the printers, and the facsimile machines, the desired image processing cannot be performed.

In addition, if the same image is repeatedly output to different output devices, the above determination process, which is of a high workload, has to be repeated, and this makes processing by software more difficult.

The image processing systems shown in FIG. 3A through FIG. 3D are able to solve this problem.

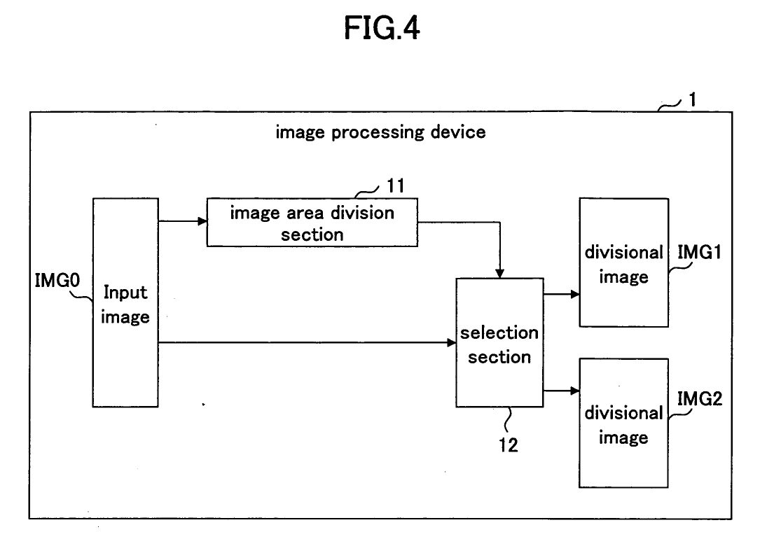

FIG. 4 is a block diagram illustrating an example of the image processing device 1.

As an example, it is assumed that the image processing device 1 in FIG. 4 carries out a process in which two divisional images IMG 1 and IMG2 are generated from an input image IMG0. Certainly, in the present invention, the number of the divisional images is not limited to two.

In FIG. 4, the image processing device 1 includes an image area division section 11 which determines which of a first area (for example, a text area) and a second area (for example, a non-text area) each of image areas of the input image IMG0 belongs to, and a selection section 12 which assigns the image area of the input image IMG0 as the divisional images IMG1, IMG2 according to the determination results of the image area division section 11.

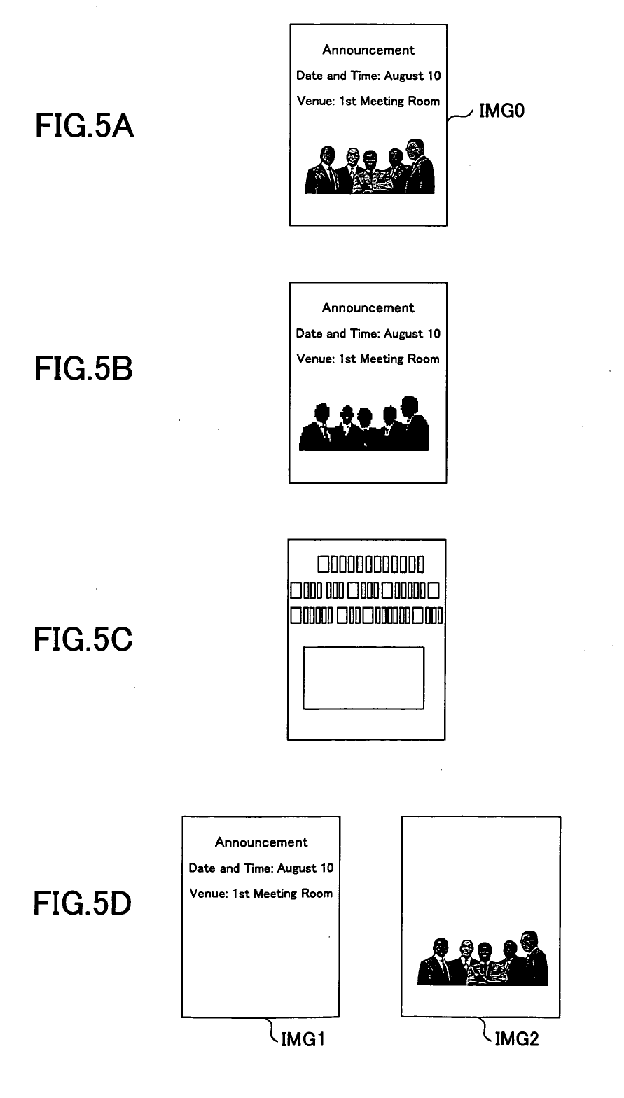

Below, an explanation is made of operations of the image processing device 1 with reference to FIG. 5A through FIG. 5D. In the following descriptions, it is assumed that the first area is a text area, and the second area is a non-text area.

FIG. 5A through FIG. 5D are views of images illustrating operations of the image processing device 1 according to the embodiment of the present invention.

As shown in FIG. 5A, the input image IMG0, which is a color/grey scale image, is input to the image area division section 11.

Next, as shown in FIG. 5B, the image area division section 11, by using a fixed threshold value, converts the input image IMG0 into a two-level image including black image areas and white image areas. It should be noted that the input image IMG0 can be converted into a two-level image by other means instead of using the fixed threshold value.

Next, as shown in FIG. 5C, the image area division section 11 creates rectangles covering each black image area. When the area of a rectangle is greater than a preset threshold, the image area division section 11 determines that the black image area covered by the rectangle is a non-text area, and when the area of the rectangle is less than the preset threshold, the image area division section 11 determines that the black image area covered by the rectangle is a text area.

Next, as shown in FIG. 5D, in accordance with the determination results of the image area division section 11, the selection section 12 uses the text area of the input image IMG0 as the divisional image IMG1, and uses the non-text area of the input image IMG0 as the divisional image IMG2. In this way, two divisional images IMG1, IMG2 are generated.

Generally, the text is expressed by two-level data; hence the divisional image IMG1, which is the text area of the input image IMG0, is stored in form of a two-level image. The divisional image IMG2, which is the non-text area of the input image IMG0, is stored in the form of a color image, the same as it is in the input image IMG0.

Note that instead of storing the divisional images IMG1, IMG2 as separate files, they can be combined and stored together, for example, in the PDF (Portable Document File) form.

Since divisional images are generated from an input image in the above way, it is possible to perform image processing at high speed compared to the determination process as disclosed in reference 1 and reference 2.

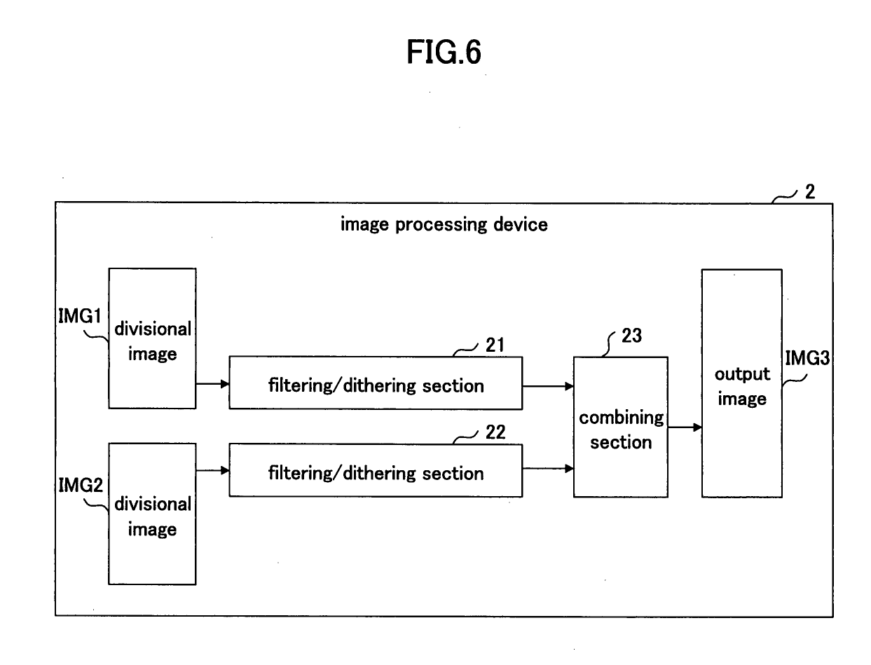

FIG. 6 is a block diagram illustrating an example of the image processing device 2.

As an example, it is assumed that the image processing device 2 in FIG. 6 carries out a process in which a combined image (indicated as an “output image”) IMG3 is generated from the two divisional images IMG 1 and IMG2. Certainly, in the present invention, the number of the divisional images is not limited to two.

In FIG. 6, the image processing device 2 includes a filtering and dithering section 21 which performs filtering and dithering on each of the divisional images IMG1, a filtering and dithering section 22 which performs filtering and dithering on each of the divisional image IMG2, and a combining section 23 which generates the output image IMG3 by combining the images obtained by the filtering and dithering sections 21, 22.

That is, in the image processing device 2, different filtering and dithering processes are performed on the divisional image IMG1 and the divisional image IMG2, and the divisional image IMG1 and the divisional image IMG2, after respective filtering and dithering processes, are combined to generate the output image IMG3.

Specifically, when the divisional image IMG1 is a text image and the divisional image IMG2 is a non-text image, since the divisional image IMG1 is a two-level image, the filtering and dithering section 21 outputs the divisional image IMG1 directly to the combining section 23 without any special processing. On the other hand, since the divisional image IMG2 is a color image, the filtering and dithering section 22 performs appropriate filtering processing (error spread processing and others), and outputs the obtained image IMG1 to the combining section 23.

When determining what filtering and dithering process is to be performed, image bit number information is used, which is written in a file header of the divisional image, to determine which of a color image or a two-level image the divisional image is, and the filtering and dithering process to be performed is determined according to the determination results.

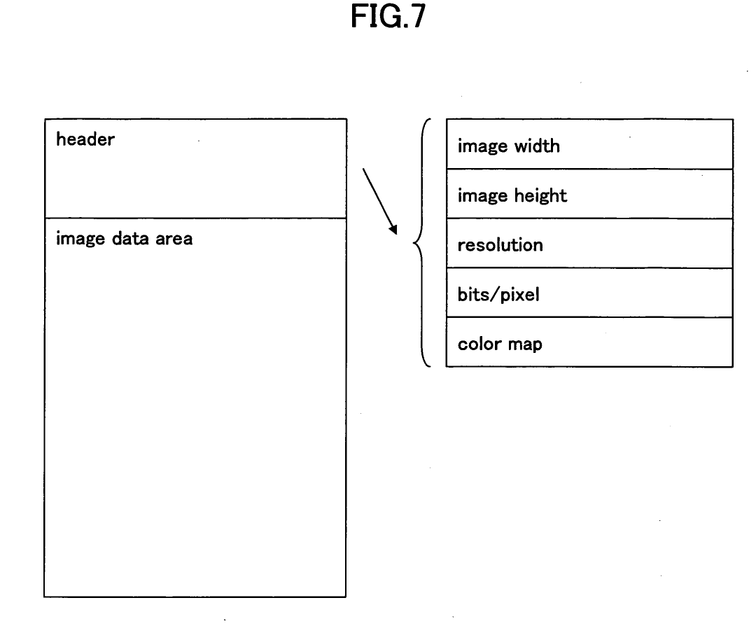

FIG. 7 is a block diagram illustrating an example of information included in an image file.

As shown in FIG. 7, the bit number per pixel information, which is included in the header, can be used to determine which of a color image or a two-level image the divisional image is. In addition, in case of a PDF file, since the bit number data are recorded as tag information, it is possible to select appropriate processing by making reference to the tag information.

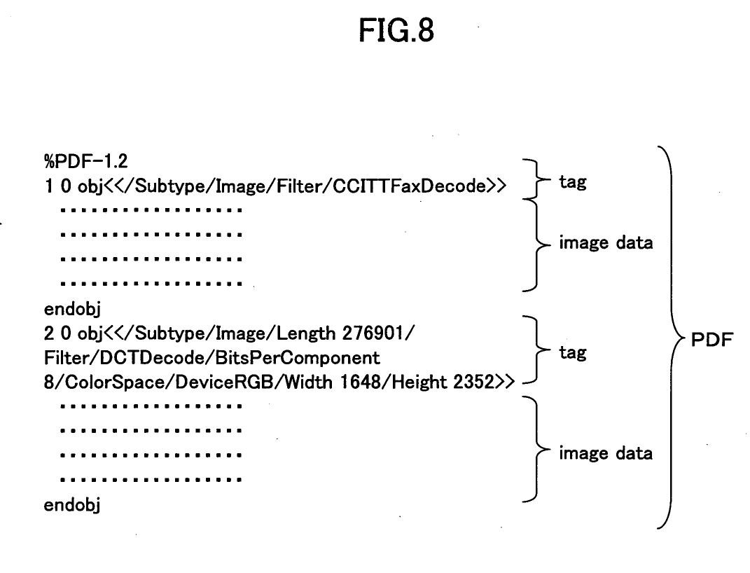

FIG. 8 is a data diagram illustrating data included in a PDF file.

For example, “CCITTFaxDecode”, “DCTDecodes”, “NCTDcode”, “BitsPerComponent 8”, which are included in tags provided for each object, can be used to determine which of a color image or a two-level image the divisional image is.

As described above, in the present invention, by employing a technique of area division of a document image, a typical one of which is a high-compression PDF technique, divisional images placed in optimized layers (areas) are output to different places by an optimized output method, and consequently, both a text portion and a picture portion of an image can be reproduced at high quality.

For example, a color image is divided into an optimum image layer by a compression scheme such as JPEG (Joint Photographic Coding Experts Group), and into an optimum image layer by a compression scheme such as MMR (Modified Modified Read (Relative element address)), and the output device is a monochromatic printer, a facsimile machine, or other devices supporting only monochromatic output. In this case, the JPEG layer image is transformed into dither or another format representing grades by a single color, overlapped with the MMR layer image, and the resulting image is output. In this process, even when the image processing device 2 does not have an ASIC or other such hardware, since the image processing device 1 has performed the high-workload processing, such as image area determination and division, the image processing device 2 just needs to perform the filtering and dithering processing only, so that high-speed image processing can be performed with software.

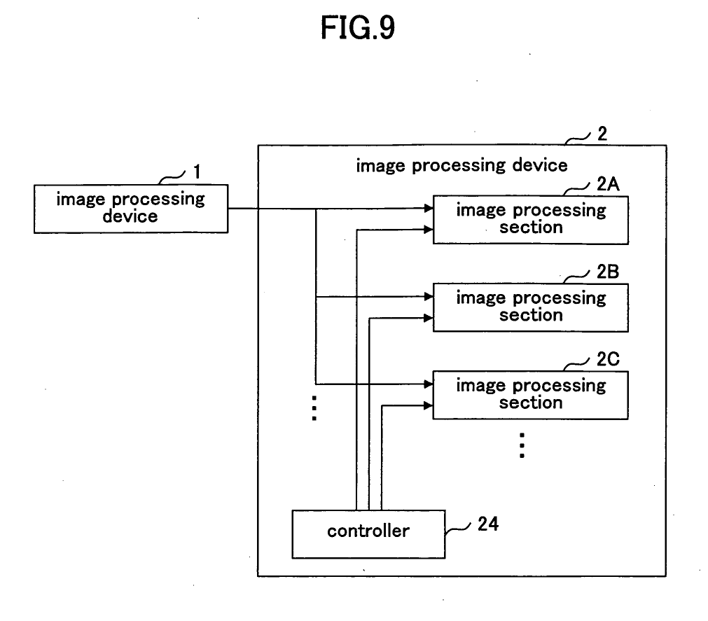

FIG. 9 is a block diagram illustrating another configuration of the image processing device 2.

In FIG. 9, the image processing device 2 includes an image processing section 2A which outputs a monochromatic image to an output device supporting only monochromatic images, such as a facsimile machine; an image processing section 2B which outputs a color image to an output device supporting color images, such as a monitor; an image processing section 2C which outputs a reduced image to an output device, such as a cellular phone; and a controller 24 which switches image processing according to the output device for a specific application.

For example, each of the image processing sections 2A, 2B, 2C has the same structure as that shown in FIG. 6. It should be noted that instead of using three image processing sections 2A, 2B, 2C, only one image processing section (for example, the image processing section 2A) may be used, and the controller 24 adjusts parameters used in image processing so that the image processing section 2A performs image processing according to the specific output device.

Specifically, in FIG. 9, when the output device is a facsimile machine, which outputs monochromatic images but not color images, the controller 24 selects the image processing section 2A, and the filtering and dithering section as shown in FIG. 6 performs dithering/error spread processing on the input color image. When the output device is a monitor, which outputs color images, the controller 24 selects the image processing section 2B to perform edging on the input color image to improve the visibility. When the output device is a cellular phone, which outputs only reduced images, the controller 24 selects the image processing section 2C to perform pixel skipping on the input color image, or perform OR compression on an input two-level image, to improve the visibility of the reduced image.

It should be noted that the filtering and dithering process performed in the image processing sections 2A, 2B, 2C, as described above is just an example; it is certain that other processing can also be performed.

With the above configuration, it is easy to change the processing depending on the situation. For example, when a facsimile machine is used and a small file size is desirable for high speed image processing, one may omit the dithering process on the non-text portion, and just simply convert the input image into a two-level image and output the obtained image. This setting can be realized very easily.

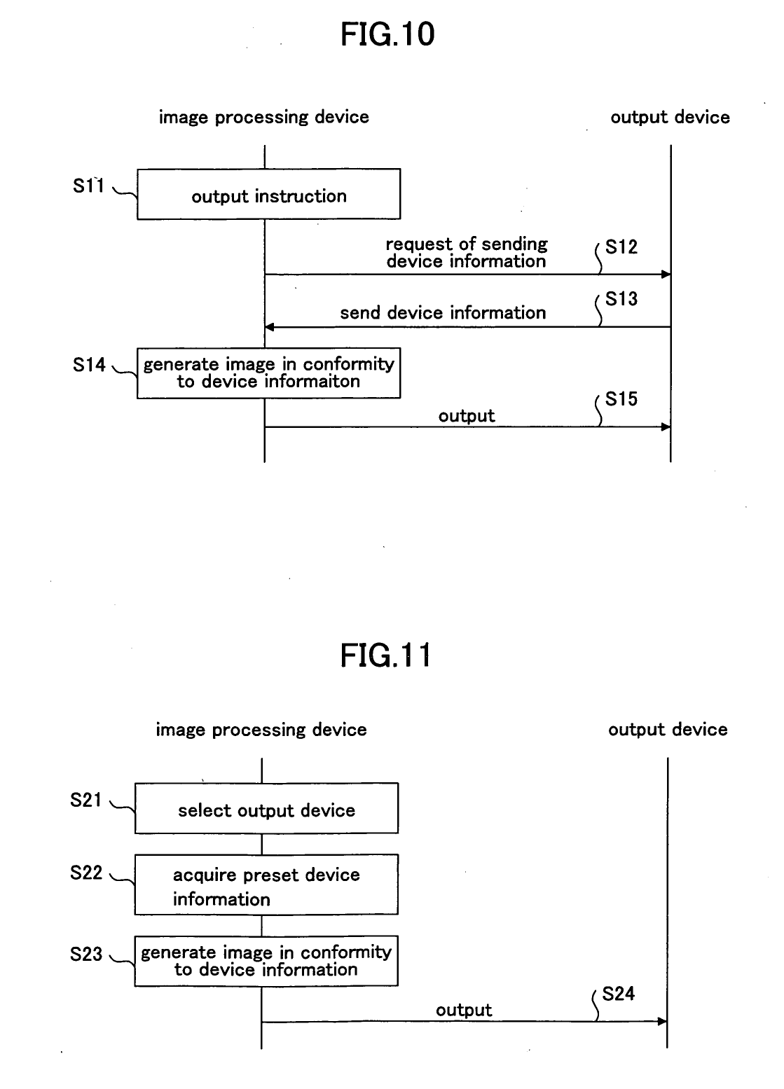

FIG. 10 is a sequence diagram illustrating operations of the image processing device 2 in FIG. 9, which generates and outputs images according to information of the output device.

FIG. 10 shows a sequence in which the image processing device 2 acquires information about the output device and changes image processing.

In step S11, a user directs to output an image.

In step S12, the image processing device 2 requests the output device to send information about the output device.

In step S13, the output device sends the information to the image processing device 2.

In step S14, the image processing device 2 generates an image according to the device information.

In step S15, the image processing device 2 outputs the generated image to the output device.

In this way, the user does not need be conscious of properties of the output device, and the image processing device 2 and the output device communicate with each other to generate and output an optimized image. In addition, in the example shown in FIG. 10, it is required that the image processing device 2 and the output device be connected to each other online bi-directionally.

FIG. 11 is a sequence diagram illustrating another example of operations of the image processing device 2 in FIG. 9, which generates and outputs images according to conditions of the output device.

Specifically, FIG. 11 shows a sequence in which the image processing device 2 changes image processing based on instructions of a user.

In step S21, the user selects the output device.

In step S22, the image processing device 2 acquires preset information about conditions of the output device.

In step S23, the image processing device 2 generates an image according to the device information, and outputs the generated image to the output device.

Here, in step S21, even when the user does not explicitly select the output device, the output device can be selected indirectly from operations of the user. For example, assume there are output devices like a monochromatic printer, a facsimile machine, a color printer, and a cellular phone. When the output device is the facsimile machine or the cellular phone, the output device can be determined from the telephone number of the output device. Specifically, when the output device is the facsimile machine or the cellular phone, the output device can be determined when the telephone number of the output device is output, or the telephone number of the output device can be registered in a phone directory and may be selected from the phone directory. The output device can be determined from operations of the telephone number of the output device. In addition, when the output device is the cellular phone, since the telephone number of the cellular phone starts from “080” or “090”, it is possible to distinguish between the facsimile machine and the cellular phone. From this information, it is possible to obtain information about the output device.

In addition, the monochromatic printer and the color printer can be distinguished from installed printer drivers of them, and the information of the driver can be used as the information of the output device. For example, the information of the output device can be recorded when installing its driver.

As described above, when the user specifies the output device, the preset information about the output device can be obtained, and the image processing device 2 generates an image according to the device information, and outputs the generated image to the output device. In addition, in comparison to the example shown in FIG. 10, in the example shown in FIG. 11, it is not necessary that the image processing device 2 and the output device be connected to each other online bi-directionally.

In the present invention, with a system including an image processing device for dividing an input image and determining properties of the divisional images, and an image processing device for appropriately transforming the divisional images according to the purpose of application, it is possible to separate processing requiring an ASIC or other hardware from other processing, thus it is possible to perform image processing for specific application with an inexpensive device. This makes it possible to perform high speed image processing even in a cellular phone or a PDA, which is not equipped with a processor of high performance.

In addition, in case of image files represented in a file format able to sustain multi-layers, which is typically used in the PDA, it is possible to perform image processing appropriately by changing later stage processing according to the image file format. Further, it is possible to determine whether image processing is necessary from information of the image grade supported by the output device.

While the present invention is described with reference to specific embodiments chosen for purpose of illustration, it should be apparent that the invention is not limited to these embodiments, but numerous modifications could be made thereto by those skilled in the art without departing from the basic concept and scope of the invention.

This patent application is based on Japanese Priority Patent Application No. 2005-312835 filed on Oct. 27, 2005, and No. 2006-260845 filed on Sep. 26, 2006, the entire contents of which are hereby incorporated by reference.

What is claimed is:

1. An image processing system, comprising:
a first image processing device configured to separate an input image into a plurality of divisional images in accordance with an output device, said divisional images being processed by different image processing methods; and
a second image processing device configured to produce an output image suitable for a specified application from the divisional images.

2. The image processing system as claimed in claim 1, wherein
the first image processing device comprises:
an image area division section configured to determine which of a first area and a second area each of a plurality of sub areas of the input image belongs to; and
a selection section configured to use the sub areas of the input image as the divisional images according to the determination result of the image area division section.

3. The image processing system as claimed in claim 1, wherein
the second image processing device comprises:
a filtering and dithering section configured to perform filtering and dithering on each of the divisional images according to one of a file format, a compression scheme, and an image bit number of the corresponding divisional image; and
a combining section configured to produce the output image by combining the images obtained by the filtering and dithering.

4. An image processing system, comprising:
a first image processing unit configured to separate an input image into a plurality of divisional images in accordance with an output device, said divisional images being processed by different image processing methods; and
a second image processing unit configured to produce an output image suitable for a specified application from the divisional images.

5. The image processing system as claimed in claim 4, wherein
the first image processing unit comprises:
an image area division section configured to determine which of a first area and a second area each of a plurality of sub areas of the input image belongs to; and
a selection section configured to use the sub areas of the input image as the divisional images according to the determination result of the image area division section.

6. The image processing system as claimed in claim 4, wherein
the second image processing unit comprises:
a filtering and dithering section configured to perform filtering and dithering on each of the divisional images according to one of a file format, a compression scheme, and an image bit number of the corresponding divisional image; and
a combining section configured to produce the output image by combining the images obtained by the filtering and dithering.

7. An image processing device, comprising:
a filtering and dithering section configured to input a plurality of divisional images, and perform filtering and dithering on each of the divisional images according to one of a file format, a compression scheme, and an image bit number of the corresponding divisional image; and
a combining section configured to produce an output image by combining the images obtained by the filtering and dithering.

8. The image processing device as claimed in claim 7, wherein
when the file format, the compression scheme, and the image bit number indicate the divisional images are color or grey scale images, the filtering and dithering section produces a two-level image able to represent a grade.

9. The image processing device as claimed in claim 7, wherein the filtering and dithering section changes processing to be performed according to an output device of the output image.

10. An image processing method, comprising the steps of:
inputting a plurality of divisional images, and performing filtering and dithering on each of the divisional images according to one of a file format, a compression scheme, and an image bit number of the corresponding divisional image; and
producing an output image by combining the images obtained by the filtering and dithering.

11. A storage medium for storing an image processing program executable on a computer and able to drive the computer to carry out the steps of:
inputting a plurality of divisional images, and performing filtering and dithering on each of the divisional images according to one of a file format, a compression scheme, and an image bit number of the corresponding divisional image; and
producing an output image by combining the images obtained by the filtering and dithering.

12. An image processing program executable on a computer and able to drive the computer to carry out the steps of:
inputting a plurality of divisional images, and performing filtering and dithering on each of the divisional images according to one of a file format, a compression scheme, and an image bit number of the corresponding divisional image; and
producing an output image by combining the images obtained by the filtering and dithering.
